(19) United States
(12) Patent Application Publication
(10) Pub. No.: US 2025/0284914 A1
(43) Pub. Date: Sep. 11, 2025

(54) AUTOMATIC REGISTRATION CONTROL SYSTEM AND STRUCTURE FOR PRINTING

(71) Applicant: Guangzhou Pulisi Technology Co., Ltd, Guangzhou (CN)

(72) Inventors: Xiaobo Lin, Guangzhou (CN); Lu Liu, Guangzhou (CN); Shengwang Liu, Guangzhou (CN); Zhenhua Meng, Guangzhou (CN); Guangbo Zou, Guangzhou (CN); Yuanchun Xu, Guangzhou (CN)

(21) Appl. No.: 19/215,379

(22) Filed: May 22, 2025

(30) Foreign Application Priority Data
May 23, 2024 (CN) 202410646812.7

(51) Int. Cl. G06K 15/02; G06K 15/00; G06T 7/00; H04N 23/56

(52) U.S. Cl. CPC G06K 15/027; G06K 15/005; G06K 15/1878; G06K 15/1894; G06K 15/4025; G06T 7/0004; H04N 23/56; G06K 2215/0094; G06K 2215/101; G06T 2207/10024; G06T 2207/30144

(57) ABSTRACT

An automatic registration control system and structure for printing are provided, and belong to the technical field of overprinting equipment. The automatic registration control system for printing includes a control module, a plurality of image capture modules electrically connected to the control module, and a drive module. The plurality of image capturing modules are in one-to-one correspondence to a plurality of nozzles of an overprinting device. The plurality of image capturing modules are respectively arranged behind the corresponding nozzles. The drive module is electrically connected to the control module. The plurality of image capturing modules are configured to: capture the paper and upload captured images to the control module. The control module adjusts stay time according to the captured images. Both adjustment precision and working efficiency can be ensured.

### TECHNICAL FIELD

The present disclosure belongs to the technical field of overprinting equipment, and in particular, to an automatic registration control system and structure for printing.

### BACKGROUND

During digital printing, colors printed by a plurality of nozzles need to be overprinted together to form a variety of colors and patterns. In the printing process, due to the impact of random factors such as displacement of printed paper and vibration or displacement of the nozzles, when the colors printed by the plurality of nozzles are overprinted to form a pattern, an overprinting deviation occurs, which seriously affects the printing effect and reduces the printing quality.

For such a situation, it is necessary to check whether layers of patterns or colors that require overprinting are aligned. In a general solution, a camera is mounted at an end of an overprinting unit to check the quality of a printed product. However, this method can detect, only after all the colors have been printed, whether the colors are aligned, and an overprinting error cannot be found out and adjusted in time. To this end, Chinese patent CN207683124U discloses an overprinting detection device with a camera image recognition function, belonging to the field of automatic printing control technologies. The overprinting detection device is composed of a camera, a tablet computer, a controller, a switch, and a host unit. The camera is used for image capturing. A camera is arranged at each workstation behind a first workstation to capture an image. The tablet computer calibrates a color code image to obtain an overprinting error and sends the error to the controller and the host unit. The controller calculates an adjustment value according to the overprinting error and sends the adjustment value to an actuator of the overprinting unit to change the position of a printing plate roller. The host unit switches real-time color code group images of the workstations through the switch, and displays the images through a display of the host unit. By the arrangement of the cameras and the controller, the device has the advantages of performing automatic detection and correction, shortening the overprinting time, and improving the overprinting precision. However, in actual printing, in order to ensure the printing efficiency, paper needs to pass through the nozzles and a space between two adjacent nozzles as quickly as possible. The recognition time of a camera between two adjacent nozzles is short, and patterns with various colors can be overprinted. When patterns with different colors are formed through overprinting, a color printed by an adjacent nozzle is likely to be closer to a color on current printing paper. For example, if a current nozzle needs to print light blue and a pattern on current paper is dark blue, it is greatly likely that the camera cannot distinguish a color difference due to the short-time capturing recognition of the camera, and the difference may be more significant. For example, if a current nozzle needs to print light blue and a pattern on current paper is red, the camera does not need to perform long-time multi-exposure recognition capturing. However, in the above solution, the camera fails to adjust the recognition time based on a corresponding printing color of a previous nozzle and a corresponding color of current paper. Low recognition precision can lead to low adjustment precision. This cannot guarantee the adjustment precision or working efficiency. Therefore, a method that ensures both the adjustment precision and the working efficiency is required.

### SUMMARY

To solve the above problems in the existing art, the present disclosure provides an automatic registration control system and structure for printing, which have the characteristic of ensuring both adjustment precision and working efficiency.

The objective of the present disclosure can be achieved by the following technical solution:

An automatic registration control system for printing includes a control module, a plurality of image capture modules electrically connected to the control module, and a drive module, wherein the plurality of image capturing modules are in one-to-one correspondence to a plurality of nozzles of an overprinting device; the plurality of image capturing modules are respectively arranged behind the corresponding nozzles;
the drive module is electrically connected to the control module; the control module instructs the drive module to drive paper to pass through in sequence and stay below the plurality of nozzles and the plurality of image capturing modules; the control module is electrically connected to the plurality of nozzles and instructs the plurality of nozzles to spray ink when the paper stays; the plurality of image capturing modules are arranged in a manner of facing the paper; the plurality of image capturing modules are configured to: capture the paper and upload captured images to the control module;
the control module inputs colors sprayed by the plurality of nozzles, and inputs in advance mixed colors formed on the paper printed by one, two, . . . , n nozzles; the control module numbers the plurality of nozzles corresponding to the plurality of image capturing modules by 1, 2, . . . , and n; and the control module respectively compares the colors sprayed by nozzles numbered with 1, 2, . . . , and n with the mixed colors formed on the paper printed by the one, two, . . . , n nozzles to obtain a plurality of color differences, and adjusts, according to a maximum value of the plurality of color differences, time that the paper stays below the image capturing modules behind the one, two, . . . , n nozzles.

In a preferred technical solution of the present disclosure, the control module inputs in advance the mixed colors formed on the paper printed by the one, two, . . . , n nozzles and the colors sprayed by the plurality of nozzles; each mixed color is a data group (R11, G11, B11), (R12, G12, B12), . . . , (R1n, G1n, B1n), and each sprayed color is a data group (R21, G21, B21), (R22, G22, B22), . . . , (R2n, G2n, B2n); the control module respectively calculates color difference data |R11−R21|+|G11−G21|+|B11−B21|, |R12−R22|+/G12−G22|+|B12−B22|, . . . , |R1n−R2n|+|G1n−G2n|+|B1n−B2n| according to the mixed color data groups and the sprayed color data groups, to obtain color difference data C1, C2, . . . , Cn, and respectively calculates, according to the color difference data, stray time t1, t2, . . . , tn that the paper stays below the image capturing modules corresponding to the nozzles numbered with 1, 2, . . . , n; the control module inputs a color difference reference value C0 and a stay time reference value to in advance; and the stay time that the control module instructs the drive module to drive the paper to stay below the image capturing modules corresponding to the nozzles numbered with 1, 2, . . . , n are respectively adjusted to t1, t2, . . . , tn, wherein a relationship between tx and Cx, C0, as well as t0 is as follows:

tx=Cx/Cx×t0×c, x=1, 2, . . . , n, and e is a constant that is input in advance.

In a preferred technical solution of the present disclosure, the control module is electrically connected to a plurality of lighting modules; and the plurality of lighting modules are in one-to-one correspondence to the plurality of image capturing modules and are configured to illuminate the paper.

In a preferred technical solution of the present disclosure, any of the lighting modules includes a ring-shaped illumination lamp; and the ring-shaped illumination lamp is arranged around an end of a lens of the image capturing module.

In a preferred technical solution of the present disclosure, the control module inputs a reference power P0 of each lighting module in advance; and the control module calculates powers of the lighting modules on the image capturing modules corresponding to nozzles 1, 2 . . . , n according to color difference values, and instructs the lighting modules to operate at power Px, wherein a relationship between Px and Cx, C0, as well as P0 is as follows: Px=C0/Cx×P0×d, x=1, 2, . . . , n, and d is a constant that is input in advance.

In a preferred technical solution of the present disclosure, the automatic registration control system for printing further includes a control panel, wherein the control panel is electrically connected to the control module; and the control panel is configured to display capturing results of the image capturing modules.

The present disclosure further provides an automatic registration control structure for printing, which is applicable to the above automatic registration control system for printing, including: a drive module and a plurality of nozzles, wherein the drive module includes a drive roller; the drive roller is configured to drive paper to move along a connecting line of the drive roller; the plurality of nozzles are arranged above the drive roller and face the drive roller; in a drive direction of the drive roller, an image capturing module is arranged behind any one of the nozzles; and a plurality of image capturing modules, the drive roller, and the nozzles are electrically connected to the control module.

The present disclosure has the beneficial effects:
(1) The control module respectively compares the colors sprayed by the nozzles numbered with 1, 2, . . . , n with the mixed colors formed on the paper printed by one, two, . . . , n nozzles, to obtain the color differences, and respectively adjusts, according to the color differences, the time that the drive module drives the paper to stay below the image capturing modules behind one, two, . . . , n nozzles. If a difference between a new printed pattern and a lower-layer pattern is small, when capturing time of the image capturing modules and determining time of the control module need to be prolonged, the stay time is automatically prolonged. If a difference between a new printed pattern and a lower-layer pattern is large, when capturing time of the image capturing modules and determining time of the control module do not need to be pronged, the stay time is automatically shortened.
(2) The control module adjusts the powers of the corresponding lighting modules according to the color difference data. If the color difference is small, when a higher lighting power and a better light filling effect are required, the powers of the lighting modules are increased, to ensure clarity of a captured image and adjustment accuracy. If the color difference is large, when a higher lighting power and a better light filling effect are not required, the powers of the lighting modules are decreased, to reduce additional power consumption.

### BRIEF DESCRIPTION OF THE DRAWINGS

For ease of understanding by those skilled in the art, the present disclosure will be further explained below in conjunction with accompanying drawings.

FIG. 1 is a schematic structural diagram of the present disclosure; and

FIG. 2 is a block diagram of a control circuit of the present disclosure.

Reference numerals of main elements:

In the drawings: 1: drive module; 11: drive roller; 2: nozzle; 3: image capturing module; 31: lighting module; 4: control module; and 5: paper.

### DETAILED DESCRIPTION OF THE EMBODIMENTS

To further elaborate the technical means and effects used by the present disclosure to achieve preset invention objectives, specific implementations, structures, features, and effects of the present disclosure are described in detail below in conjunction with the accompanying drawings and preferred embodiments.

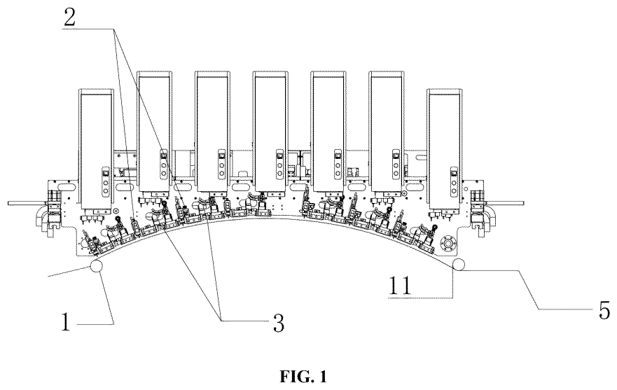

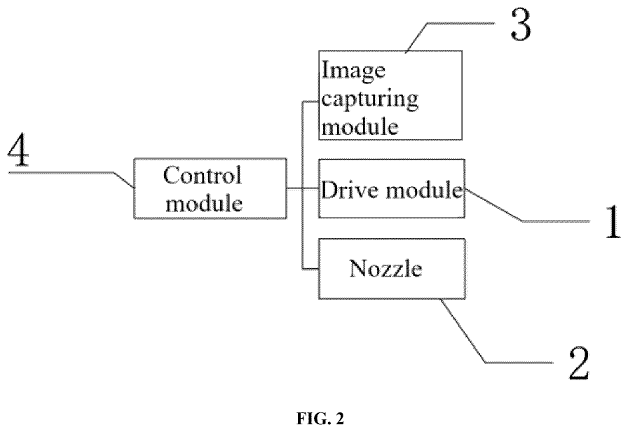

Referring to FIG. 1 to FIG. 2, an automatic registration control system and structure for printing. The automatic registration control system includes a control module 4 and a drive module 1 electrically connected to the control module 4. Specifically, the drive module 1 is electrically connected to the control module 4. The control module 4 instructs the drive module 1 to drive paper 5 to pass through in sequence and stay below a plurality of nozzles 2. The drive module 1 at least includes two drive rollers 11 that are arranged in parallel. The two drive rollers 11 are connected to the control module 4 through an encoder. An electrical signal of the control module 4 is converted by the encoder into an action of the drive rollers 11. The control module 4 controls a paper feeding distance of the drive module 1 through the encoder, and an overprinting station is formed between the two drive rollers 11. Specifically, a overprinting device further includes the plurality of nozzles 2. The plurality of nozzles 2 are arranged above the overprinting station formed by the drive module 1 and are aligned with the overprinting station. The plurality of nozzles 2 are arranged in a row in a direction of a connecting line of the two drive rollers 11.

During use, the two drive rollers 11 are instructed by the control module 4 and the encoder to drive the paper 5 on the drive rollers to move forwards and stay alternately in the overprinting station. When a part to be printed of the paper 5 stays below a nozzle 2, one of the nozzles 2 aligned with the overprinting station prints the part to be printed below. Colored ink sprayed by the nozzle 2 forms a color layer on the paper 5. Subsequently, the drive module 1 drives the paper 5 and the part to be printed of the paper 5 to move forwards, and the drive module 1 causes the paper 5 to stay until the part to be printed is aligned with a next nozzle 2. In this case, the part to be printed is aligned with the next nozzle 2, and the next nozzle 2 prints the part to be printed below. The above process is repeated until all the nozzles 2 have printed patterns on the part to be printed. A plurality of layers of patterns form an overprinted pattern, thus completing registration printing.

In the above process, the drive module 1, the nozzles 2, and the paper 5 need to cooperate together to print the patterns printed by the plurality of nozzles 2 to the same position on the paper 5. When one pattern deviates from a target position, a printing effect may decrease. There is an error in each process that the encoder converts the electrical signal of the control module 4 into a signal of a material paper feeding length, so that if the paper 5 moves to the nozzle 2 and a corresponding printing station that are closer to a rear end in a paper feeding direction, an error accumulated in a paper feeding distance is larger. For example, it has been experimentally proven that when a total paper feeding length is 20 to 30Cx, an accumulated error of the encoder may cause a positional deviation of 0.06 mm between patterns printed at the part to be printed by the first and last nozzles 2 in the paper feeding direction. Layers of patterns that should overlap may no longer overlap, and the printing effect is reduced. To this end, it is necessary to perform error correction according to a real-time printing deviation to prevent a further decrease in the printing effect because of an increasingly large error. The system further includes a plurality of image capturing modules 3 electrically connected to the control module 4. The plurality of image capturing modules 3 are in one-to-one correspondence to the plurality of nozzles 2 of the overprinting device. In the paper feeding direction, each image capturing module 3 is arranged behind the corresponding nozzle 2. The control module 4 instructs the drive module 1 to drive the paper 5 to pass through i sequence and stay below the plurality of nozzles 2 and the plurality of image capturing modules.

For each image capturing module 3, specifically, the image capturing module 3 includes at least one camera, and each camera is electrically connected to the control module.

Specifically, when the overprinting device includes a total of n nozzles 2, the control module 4 numbers the nozzles 2 corresponding to the plurality of image capturing modules by 1, 2, . . . , n. For example, the paper feeding direction is used as a reference direction. In the reference direction, a first nozzle 2 in the reference direction is 1-st nozzle 2, a second nozzle 2 is 2-nd nozzle 2, and so on.

During use, when the part to be printed is printed with a pattern by a nozzle 2, the drive module 1 drives the part to be printed to continue to move forwards in the paper feeding direction until the part is aligned with the image capturing module corresponding to the nozzle 2. The drive module 1 causes the paper 5 to stay. In this case, the part to be printed stays below the camera. The control module 4 synchronously instructs the camera to be turned on to capture the part to be printed below, and then the camera uploads a captured image to the control module 4. After receiving the pattern, the control module 4 synchronously adjusts the electrical signal sent to the encoder.

For example, when the control module 4 instructs the encoder to move the drive module 1 to a nozzle 2, and a deviation of a paper feeding distance of the encoder itself reaches 0.03 mm, there are two non-overlapping patterns on the paper 5, and a misalignment distance between the two patterns is 0.03 mm. The camera captures an image of the patterns and uploads the image to the control module 4. The control module 4 analyzes the image to determine the misalignment distance between the two patterns and instructs, according to the misalignment distance, the encoder to perform correction. In this case, when the control module 4 instructs the encoder to send a signal that indicates movement to a next nozzle 2, an additional 0.03 mm movement signal is sent. In this case, the part to be printed can be aligned with the next nozzle 2 to complete the correction on overprinting.

In the above process, since jet printing needs to be completed as quickly as possible, the time that the drive module 1 drives the paper 5 to stay under the camera needs to be shortened as much as possible. A clarity of an image captured by the camera is in positive correlation with the capturing time within a range, and the control module 4 also needs to use the stay time to analyze the image. When the stay time is too short, there is a probability that the capturing time and the analysis time are not enough, which will affect the adjustment precision. However, when the stay time is too long, the working efficiency is low. For example, if a current nozzle 2 needs to print light blue and a current pattern on the paper is dark blue, there is a larger probability that the image capturing module 3 cannot distinguish a color difference during short-time capturing recognition, and it is likely that the difference is outstanding. For example, if a current nozzle 2 needs to print light blue and a current pattern on the paper is red, the image capturing module 3 does not need to perform long-time multi-exposure recognition capturing.

Therefore, in order to adjust the stay time according to an actual situation, the control module 4 inputs colors sprayed by the plurality of nozzles 2. The control module 4 inputs inn advance mixed colors formed on the paper 5 printed by one, two, . . . , n nozzles 2. The control module 4 compares the colors sprayed by nozzles 2 numbered with 1, 2, . . . , n with the mixed colors formed on the paper 5 printed by one, two, . . . , n nozzles 2, to obtain color differences, i.e., obtain a plurality of color difference values. Afterwards, control module 4 selects a maximum color difference value from the plurality of color difference values and adjusts, according to the maximum color difference value, the time that the drive module 1 drives the paper 5 to stay under the cameras.

Specifically, all color data, including the mixed colors and the colors printed by the nozzle 2, are composed of a group of RGB values, such as (R11, G11, B11), (R12, G12, B12), . . . , (R1n, G1n, B1n). Specifically, a color of a pattern printed by a first nozzle 2 on the paper 5 is (R11, G11, B11), and a color of a pattern mixed and formed on the paper 5 by overprinting by the first and second nozzles 2 is (R12, G12, B12) . . . . A color of a pattern mixed and formed on the paper 5 by overprinting by the n nozzles 2 is (R1n, G1n, B1n). A color of a pattern is simulated and obtained by working personnel by using computer software. Meanwhile, the control module 4 also inputs in advance RGB values of colors of paint sprayed by the first to n-th nozzles 2, such as (R21, G21, B21), (R22, G22, B22), . . . , (R2n, G2n, B2n).

Subsequently, the control module 4 calculates the color differences to obtain a plurality of pieces of color difference data C1, C2, . . . , Cn. The control module 4 inputs a color difference reference value C0 and a stay time reference value to in advance. Based on the color difference data, the control module 4 respectively calculates stay time t1, t2, . . . , tn of the paper 5 below the image capturing modules corresponding to the nozzles 2 numbered with 1, 2, . . . , n, and respectively adjusts the stay time that the drive module 1 drives the paper 5 to stay below the image capturing modules corresponding to the nozzles 2 numbered with 1, 2, . . . , n to t1, t2, . . . , tn. A relationship between t and Cx, C0, and t0 is as follows:

t=C0/Cx×t0×c, where e is a constant that is input in advance, Cx≥1. When the calculation shows Cx<1, the control module 4 takes Cx=1.

In practical use, when a pattern is printed by x nozzles 2 and there is a deviation, a latest printed pattern on a top layer may be misaligned with a lower-layer pattern. In this case, a part of the latest printed pattern overlaps with the lower-layer pattern, and color values of the overlapping part are (R1x, G1x, B1x), and a color printed by a previous nozzle 2 is (R2, G2x, B2x). Since the deviated part of the latest printed pattern does not overlap the lower-layer pattern and is directly printed on the paper, the color of the deviated part is also (R2x, G2x, B2x), which deviates from the color of the lower-layer pattern. When the control module 4 determines a deviation value according to the image uploaded by the image capturing module 3, and determines a specific deviation distance by determining a boundary distance between the pattern with the color (R1x, G1x, B1x) and the pattern with the color (R2x, G2x, B2x).

When a value of |R1x−R2x|+|G1x−G2x|+|B1x−B2x| calculated by the control module 4 according to (R2x, G2x, B2x) and (R1x, G1x, B1x) is small, it means that a difference between a new printed pattern and a lower-layer pattern is small. It is not easy to determine a boundary distance, and the capturing time of the image capturing module 3 and the determining time of the control module 4 need to be prolonged. In this case, Cx is relatively small, tx=Cx/Cx×t0×c is relatively large. When the control module 4 adjusts that the drive module 1 drives, after the paper is printed by a nozzle 2 numbered with x, the paper to stay for tx below the camera corresponding to the nozzle 2 numbered with x, and a color difference between the deviated part and the overlapping part is small, the stay time is correspondingly prolonged, thereby prolonging the capturing time of the image capturing module 3 and the determining time, improving the determining accuracy, reducing inaccuracy of adjustment caused by inaccurate determination, and ensuring the adjustment accuracy when colors are close.

On the contrary, when a value of |R1x−R2x|+|G1x−G2x|+|B1x−B2x| is large, it means that there is a large difference between a new printed pattern and a lower-layer pattern, and it is easy to determine a boundary distance. There is no need to prolong the capturing time of the image capturing module 3 and the determining time of the control module 4. In this case, Cx is relatively large, and tx=Cx/Cx×t0×c is relatively small. When the control module 4 instructs the drive module 1 to drive, after the paper is printed by a nozzle 2 numbered with x, the paper to stay for tx below the camera corresponding to the nozzle 2 numbered with x, and a color difference between the deviated part and the overlapping part is large, the stay time is correspondingly shortened, thereby shortening the capturing time of the image capturing module 3 and the determining time, and ensuring determining accuracy and working efficiency.

The control module 4 respectively compares the colors sprayed by the nozzles 2 numbered with 1, 2, . . . , n with the mixed colors formed on the paper 5 printed by one, two, . . . , n nozzles 2, to obtain the color differences, and respectively adjusts, according to the color differences, the time that the drive module 1 drives the paper 5 to stay below the image capturing modules behind one, two, . . . , n nozzles 2. If a difference between a new printed pattern and a lower-layer pattern is small, when capturing time of the image capturing modules and determining time of the control module 4 need to be prolonged, the stay time is automatically prolonged. If a difference between a new printed pattern and a lower-layer pattern is large, when capturing time of the image capturing modules and determining time of the control module do not need to be pronged, the stay time is automatically shortened.

In the capturing process of the above image capturing module 3, there may be a situation in which the nozzle 2 and the image capturing module 3 block ambient light. In this case, an image captured by the image capturing module 3 has low clarity. In order to prevent this situation, the control module 4 is electrically connected to a plurality of lighting modules 31. The plurality of lighting modules 31 are in one-to-one correspondence to the plurality of image capturing modules 3 and are configured to illuminate parts captured by the cameras. Specifically, in order to save a space and reduce ghosting, each lighting module 31 includes a ring-shaped illumination lamp. The ring-shaped illumination lamp is arranged around an end of a lens of the image capturing module 3 and faces the lens of the image capturing module 3. In this case, the lighting module 31 can illuminate an object captured by the image capturing module 3, to provide supplementary lighting for the lighting module 31, which improves the clarity of a captured image, improving the determining accuracy of the control module 4 based on the captured image, and improving the adjustment precision.

In the lighting process of each lighting module 31, an excessive lighting power can cause additional energy consumption, and a low lighting power can cause a poor light filling effect. When a color difference between a new printed pattern and a lower-layer pattern is small, an additional light filling intensity is required to ensure image accuracy. When the color difference is large, there is no requirement for a high light filling intensity. To this end, the image capturing modules corresponding to the nozzles 2 numbered with 1, 2, . . . , n are also numbered with 1, 2, . . . , n. The control module 4 inputs reference powers P0 of the lighting modules 31 in advance. The control module 4 calculates powers of the lighting modules 31 according to a color difference value, and instructs the lighting modules 31 numbered with 1, 2, . . . , n to operate at power Px, where a relationship between P and Cx, C0, as well as P0 is: Px=C0/Cx×P0×d, x=1, 2, . . . , n, and d is a constant input in advance.

When the value of Cx is small, and the deviated part and the overlapping part have close colors, the value of Px=C0/Cx×P0×d is large. Therefore, when the color difference is small, and a higher lighting power and a better light filling effect are required, the powers of the lighting modules 31 are increased, to ensure clarity of a captured image and adjustment accuracy. When the value of Cx is large, and the deviated part and the overlapping part have significantly different colors, the value of Px=C0/Cx×P0×d is small. If the color difference is large, when a higher lighting power and a better light filling effect are not required, the powers of the lighting modules 31 are decreased, to reduce additional power consumption.

To facilitate working personnel to observe a capturing result and determine whether the clarity of the capturing result meets an automatic determining standard, the automatic registration control system for printing further includes a control panel. The control panel is electrically connected to the control module 4; and the control panel is configured to display capturing results of the image capturing modules.

The present disclosure further provides an automatic registration structure, which is applicable to the above automatic registration control system for printing, including: a drive module 1 and a plurality of nozzles 2. The drive module 1 includes a drive roller 11. The drive roller 11 is configured to drive paper 5 to move along a connecting line of the drive roller 11. The plurality of nozzles 2 are arranged above the drive roller 11 and face the drive roller 11. In a drive direction of the drive roller 11, an image capturing module 3 is arranged behind any one of the nozzles 2. A plurality of image capturing modules 3, the drive roller 11, and the nozzles 2 are electrically connected to the control module 4.

The above descriptions are merely the preferred embodiments of the present disclosure and are not intended to make any form of limitation on the present disclosure. Although the present disclosure has been disclosed with the preferred embodiments as mentioned above, it is not intended to limit the present disclosure. Any of those skilled in the art, without departing from the technical scope of the present disclosure, may make some changes or modifications according to the disclosed technical content to form equivalent embodiments. As long as these simple amendments, equivalent changes, and modifications fall within the contents of the technical solutions of the present disclosure according to the technical substance of the present disclosure, they shall all fall within the scope of the technical solutions of the present disclosure.

What is claimed is:

1. An automatic registration control system for printing, comprising a control module, a plurality of image capture modules electrically connected to the control module, and a drive module, wherein the plurality of image capturing modules are in one-to-one correspondence to a plurality of nozzles of an overprinting device; the plurality of image capturing modules are respectively arranged behind the corresponding nozzles;
the drive module is electrically connected to the control module; the control module instructs the drive module to drive paper to pass through in sequence and stay below the plurality of nozzles and the plurality of image capturing modules; the control module is electrically connected to the plurality of nozzles and instructs the plurality of nozzles to spray ink when the paper stays; the plurality of image capturing modules are arranged in a manner of facing the paper; the plurality of image capturing modules are configured to: capture the paper and upload captured images to the control module;
the control module inputs colors sprayed by the plurality of nozzles, and inputs in advance mixed colors formed on the paper printed by one, two, . . . , n nozzles; the control module numbers the plurality of nozzles corresponding to the plurality of image capturing modules by 1, 2, . . . , and n; and the control module respectively compares the colors sprayed by nozzles numbered with 1, 2, . . . , and n with the mixed colors formed on the paper printed by the one, two, . . . , n nozzles to obtain a plurality of color differences, and adjusts, according to a maximum value of the plurality of color differences, time that the paper stays below the image capturing modules behind the one, two, . . . , n nozzles.

2. The automatic registration control system for printing according to claim 1, wherein the control module inputs in advance the mixed colors formed on the paper printed by the one, two, . . . , n nozzles and the colors sprayed by the plurality of nozzles; each mixed color is a data group (R11, G11, B11), (R12, G12, B12), . . . , (R1n, G1n, B1n), and each sprayed color is a data group (R21, G21, B21), (R22, G22, B22), . . . , (R2n, G2n, B2n); the control module respectively calculates color difference data (R11−R21|+|G11−G21|+|B11−B21|, R12−R22|+|G12−G22|+|B12−B22|, . . . , |R1n−R2n|+/G1n−G2n|+|B1n−B2n| according to the mixed color data groups and the sprayed color data groups, to obtain color difference data C1, C2, . . . , Cn, and respectively calculates, according to the color difference data, stray time t1, t2, . . . , tn that the paper stays below the image capturing modules corresponding to the nozzles numbered with 1, 2, . . . , n; the control module inputs a color difference reference value C0 and a stay time reference value to in advance; and the stay time that the control module instructs the drive module to drive the paper to stay below the image capturing modules corresponding to the nozzles numbered with 1, 2, . . . , n are respectively adjusted to t1, t2, . . . , tn, wherein a relationship between tx and Cx, C0, as well as to is as follows:
tx=Cx/Cx×t0×c, x=1, 2, . . . , n, and e is a constant that is input in advance.

3. The automatic registration control system for printing according to claim 1, wherein the control module is electrically connected to a plurality of lighting modules; and the plurality of lighting modules are in one-to-one correspondence to the plurality of image capturing modules and are configured to illuminate the paper.

4. The automatic registration control system for printing according to claim 3, wherein any of the lighting modules comprises a ring-shaped illumination lamp; and the ring-shaped illumination lamp is arranged around an end of a lens of the image capturing module.

5. The automatic registration control system for printing according to claim 3, wherein the control module inputs a reference power P0 of each lighting module in advance; and the control module calculates powers of the lighting modules on the image capturing modules corresponding to nozzles 1, 2 . . . , n according to color difference values, and instructs the lighting modules to operate at power Px, wherein a relationship between Px and Cx, C0, as well as P0 is as follows:
Px=C0/Cx×P0×d, x=1, 2, . . . , n, and d is a constant that is input in advance.

6. The automatic registration control system for printing according to claim 1, further comprising a control panel, wherein the control panel is electrically connected to the control module; and the control panel is configured to display capturing results of the image capturing modules.

7. An automatic registration control structure for printing, which is applicable to the automatic registration control system for printing according to claim 1, comprising: a drive module and a plurality of nozzles, wherein the drive module comprises a drive roller; the drive roller is configured to drive paper to move along a connecting line of the drive roller; the plurality of nozzles are arranged above the drive roller and face the drive roller; in a drive direction of the drive roller, an image capturing module is arranged behind any one of the nozzles; and a plurality of image capturing modules, the drive roller, and the nozzles are electrically connected to the control module.
